(19) United States
(12) Patent Application Publication
(10) Pub. No.: US 2012/0227837 A1
(43) Pub. Date: Sep. 13, 2012

(54) CHECK VALVE OF HYDRAULIC BRAKE SYSTEM

(75) Inventor: Chung Jae Lee, Gyeonggi-do (KR)

(73) Assignee: MANDO CORPORATION

(21) Appl. No.: 13/416,689

(22) Filed: Mar. 9, 2012

(30) Foreign Application Priority Data
Mar. 11, 2011 (KR) 10-2011-0021772
Mar. 23, 2011 (KR) 10-2011-0025721

(51) Int. Cl. F16K 15/00

(52) U.S. Cl. 137/511

(57) ABSTRACT

Disclosed is a check valve of a hydraulic brake system. The check valve includes a valve housing which includes an inner-diameter portion configured to support a ball, an expanded cylindrical body portion and an outer-diameter portion circumferentially extending from the body portion, and a valve seat which includes a first body portion extending in a bent shape from an oil hole and configured to support the spring therein, a second body portion having a greater diameter than the first body portion and press-fitted to the body portion of the valve housing, a third body portion circumferentially extending from the second body portion to come into surface contact with the outer-diameter portion and be press-fitted into an inner stepped portion of a perforated block. The check valve having a simplified configuration achieves size and weight reduction and is manufactured at low cost and high processing efficiency using pressing.

### CROSS-REFERENCE TO RELATED APPLICATIONS

This application claims the benefit of Korean Patent Applications No. 2011-0021772, filed on Mar. 11, 2011 and No. 2011-0025721 filed on Mar. 23, 2011 in the Korean Intellectual Property Office, the disclosure of which is incorporated herein by reference.

### BACKGROUND

1. Field

Embodiments of the present invention relate to a check valve of a hydraulic brake system having a simplified configuration to ensure easy processing and assembly.

2. Description of the Related Art

A vehicle is essentially provided with a brake system for braking. Recently, a variety of brake systems to achieve stronger and stabilized brake force has been proposed. Examples of brake systems include an Anti-lock Brake System (ABS) that prevents wheel slip during braking, a Brake Traction Control System (BTCS) that prevents sudden unintended acceleration of a vehicle or slip of driving wheels upon sudden acceleration, and a Vehicle Dynamic Control System (VDCS) that is a combination of an ABS and BTCS and stably maintains traveling of a vehicle by controlling brake oil pressure.

Such an electronically controlled brake system includes a plurality of solenoid valves to control hydraulic brake pressure transmitted to hydraulic brakes mounted to wheels of a vehicle, a pair of low-pressure and high-pressure accumulators in which oil discharged from the hydraulic brakes is temporarily stored, a motor and pump to forcibly pump the oil of the low-pressure accumulator, a plurality of check valves to prevent backflow of oil, and an Electronic Control Unit (ECU) to control operations of the solenoid valves and motor. These components are accommodated in a compact aluminum hydraulic block.

FIG. 1 is a sectional view illustrating a check valve used in a conventional electronically controlled brake system. In one example, a check valve, which is installed in a path between a suction side of a pump and a low-pressure accumulator, functions to prevent oil of a master cylinder from being transmitted to the low-pressure accumulator and also, to prevent oil of a wheel cylinder from entering the suction side of the pump when a motor is driven to operate the pump.

As illustrated, a check valve 1 includes a valve housing 3 press-fitted into a hydraulic block 2 having an oil path 2a, a ball 4 accommodated in the valve housing 3 to open or close an oil passage 3a defined in the valve housing 3, a spring 5 to elastically support the ball 4 toward the oil passage 3a, and a spring seat 6 assembled into the valve housing 3 to guide the spring 5.

The above-described conventional check valve 1, however, has a complicated external appearance and is difficult to assemble because only functionality is considered upon manufacture thereof. In particular, the valve housing 3 having a complicated shape as illustrated causes a large product size and expensive manufacturing costs because it is manufactured only by cutting. In addition, since the spring seat 6 is press-fitted only into the valve housing 3, assembly reliability is deteriorated after long-term use.

### SUMMARY

Therefore, it is an aspect of the present invention to provide a check valve of a hydraulic brake system having a simplified configuration to ensure easy processing and assembly.

Additional aspects of the invention will be set forth in part in the description which follows and, in part, will be obvious from the description, or may be learned by practice of the invention.

In accordance with one aspect of the present invention, a check valve of a hydraulic brake system includes a valve housing press-fitted into an inner stepped portion of a perforated hydraulic block, the valve housing defining an inner oil passage, a ball accommodated in the valve housing to open or close the inner oil passage, a spring to elastically support the ball, and a valve seat coupled to the valve housing to guide the spring, wherein the valve housing includes an inner-diameter portion provided at the center thereof with the oil passage, the inner-diameter portion having a concave shape to support the ball, a cylindrical body portion expanded from the inner-diameter portion, and an outer-diameter portion circumferentially extending from the body portion, and wherein the valve seat includes a first body portion extending in a bent shape from an oil hole and configured to support the spring therein, a second body portion having a greater diameter than the first body portion and press-fitted to the body portion of the valve housing, a third body portion circumferentially extending from the second body portion to come into surface contact with the outer-diameter portion of the valve housing and be press-fitted into the inner stepped portion of the perforated block.

The perforated block may further include an outer stepped portion, and the outer stepped portion may be press-deformed to fix the outer-diameter portion of the valve housing press-fitted into the inner stepped portion.

The outer-diameter portion of the valve housing and the third body portion of the valve seat may be supported at both front and rear sides thereof by the perforated block.

In accordance with another aspect of the present invention, a check valve of a hydraulic brake system includes a valve housing press-fitted into an inner stepped portion of a perforated hydraulic block, the valve housing defining an inner oil passage, a ball accommodated in the valve housing to open or close the inner oil passage, a spring to elastically support the ball, and a valve seat coupled to the valve housing to guide the spring, wherein a valve housing includes a tapered portion provided at the center thereof with the oil passage, and a cylindrical body portion extending from the tapered portion, and wherein a valve seat includes a cylindrical inner-diameter portion extending in a bent shape from a center oil hole to support a spring therein, an inner-diameter expanding portion circumferentially extending from the inner-diameter portion and press-fitted into and supported by the inner stepped portion of the perforated block, a cylindrical outer-diameter portion extending perpendicular to the inner-diameter expanding portion to come into contact at an inner surface thereof with the body portion of the valve housing, and an outer-diameter reducing portion tapered from the outer-diameter portion to come into surface contact with the tapered portion of the valve housing.

The perforated block may further include an outer stepped portion, and the outer stepped portion may be press-deformed to fix the outer-diameter reducing portion of the valve seat press-fitted into the inner stepped portion.

The outer-diameter reducing portion and the inner-diameter expanding portion of the valve seat may be supported at both front and rear sides thereof by the perforated block.

The outer-diameter reducing portion may be formed by inserting the spring, ball and valve housing into the valve seat having the same diameter as the outer-diameter portion and thereafter, assembling the outer-diameter reducing portion so as to be shape-coincident with the tapered portion of the valve housing.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating a check valve of a conventional brake system;

FIG. 2 is a view illustrating a brake system using a check valve according to an embodiment of the present invention;

FIG. 3 is a view illustrating a check valve of a brake system according to one embodiment of the present invention; and

FIG. 4 is a view illustrating a check valve of a brake system according to another embodiment of the present invention.

### DETAILED DESCRIPTION

Reference will now be made in detail to the embodiments of the present invention, examples of which are illustrated in the accompanying drawings, wherein like reference numerals refer to like elements throughout.

First, prior to explaining a check valve of a brake system according to an embodiment of the present invention, a brake system using a check valve will be described in brief.

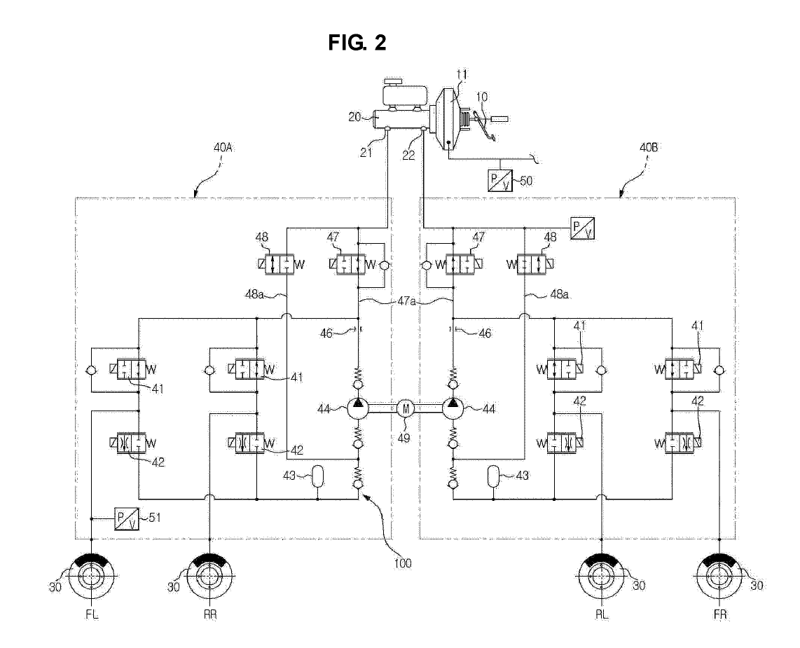

FIG. 2 is a view illustrating a conventional brake system. The electronically controlled brake system includes a brake pedal 10 to which operating force is applied by a driver, a brake booster 11 to double pedal force of the brake pedal 10 using a pressure difference between vacuum pressure and air pressure, a master cylinder 20 to generate pressure under assistance of the brake booster 11, a first hydraulic circuit 40A which connects a first port 21 of the master cylinder 20 to two wheel brakes (or wheel cylinders) 30 and controls transmission of oil pressure, and a second hydraulic circuit 40B which connects a second port 22 of the master cylinder 20 to the other two wheel brakes 30 and controls transmission of oil pressure. The first hydraulic circuit 40A and the second hydraulic circuit 40B are installed in a compact hydraulic block (not shown).

Each of the first hydraulic circuit 40A and the second hydraulic circuit 40B includes solenoid valves 41 and 42 to control hydraulic brake pressure to be transmitted to the two wheel brakes 30, a pump 44 to suction and pump oil discharged from the wheel brakes 30 or oil directed from the master cylinder 20, a low-pressure accumulator 43 in which the oil discharged from the wheel brakes 30 is temporarily stored, an orifice 46 to reduce pressure pulsation of oil pumped from the pump 40, and an auxiliary flow line 48a to guide suction of oil from the master cylinder 20 to an entrance of the pump 44 in a Traction Control (TCS) mode.

The plurality of solenoid valves 41 and 42 are arranged upstream and downstream of the wheel brakes 30. Specifically, the solenoid valves include a normal open type solenoid valve 41 which is placed upstream of each wheel brake 30 and is normally kept open, and a normal close type solenoid valve 42 which is placed downstream of each wheel brake 30 and is normally kept closed. Opening/closing operations of the solenoid valves 41 and 42 are controlled by an Electronic Control Unit (ECU: not shown) that senses a vehicle speed via a wheel speed sensor installed to each wheel. In a dump mode, the normal close type solenoid valve 42 is opened and the oil discharged from the wheel brake 30 is temporarily stored in the low-pressure accumulator 43.

The pump 44 is driven by a motor 49 and serves to suction the oil stored in the low-pressure accumulator 43 and discharge the oil to the orifice 46, thereby transmitting oil pressure to the wheel brake 30 or the master cylinder 20.

A main flow line 47a, which connects the master cylinder 20 and an exit of the pump 44 to each other, is provided with a normal open type solenoid valve 47 for traction control (hereinafter referred to as TC valve). The TC valve 47 is normally kept open to transmit brake oil pressure generated in the master cylinder 20 to the wheel brake 30 through the main flow line 47a upon normal braking via the brake pedal 10.

The auxiliary flow line 48a is branched from the main flow line 47a and guides suction of oil from the master cylinder 20 to the entrance of the pump 44. A shuttle valve 48 is installed on the auxiliary flow line 48a to make sure that the oil flows only to the entrance of the pump 44. The electrically operated shuttle valve 48 is installed on a certain position of the auxiliary flow line 48a and is normally closed and is opened in a TCS mode.

The brake booster 11 is provided with a pressure sensor 50 to sense air pressure and vacuum pressure of the brake booster 11. Also, wheel pressure sensors 51 are provided to sense actual brake pressure applied to front left and right wheels FL and FR and rear left and right wheels RL and RR. These pressure sensors 50 and 51 are electrically connected to and controlled by the ECU.

A braking operation of the vehicular hydraulic brake system having the above-described configuration according to the embodiment of the present invention is as follows.

First, the driver will push the brake pedal 10 when it is necessary to reduce a vehicle speed during traveling or keep a vehicle stationary after stopping. The brake booster 11 doubles input force from the brake pedal 10, thereby assisting the master cylinder 20 in generating great hydraulic brake pressure. The generated hydraulic brake pressure is transmitted to the front wheels FR and FL and the rear wheels RL and RR via the solenoid valves 41 and 42, realizing a braking operation. Then, if the driver gradually or completely removes their foot from the brake pedal 10, oil pressure in each wheel brake is returned to the master cylinder 20 via the solenoid valves 41 and 42, causing reduction or complete removal of brake force.

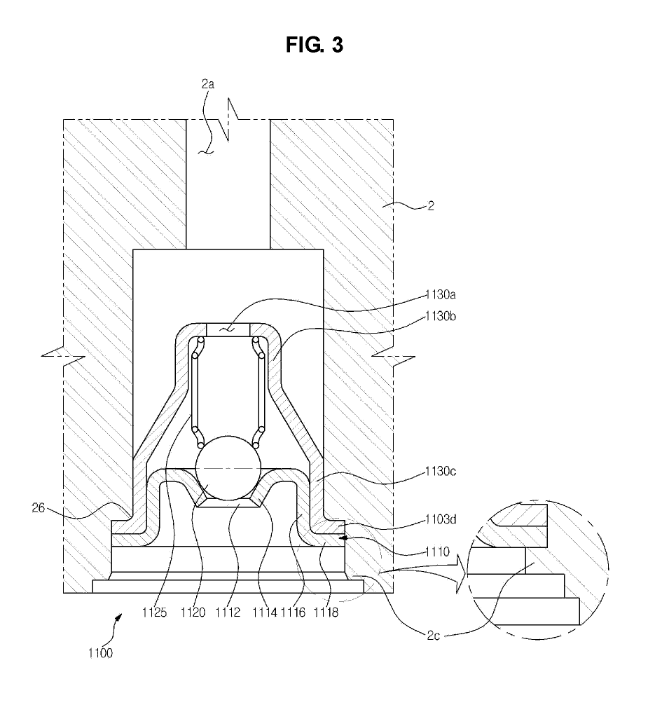

FIG. 3 is a view illustrating a check valve of a brake system according to one embodiment of the present invention. Although a check valve 1100 of the present embodiment is installed between a suction side of the low-pressure accumulator 43 and the pump 44 in FIG. 2, an installation position of the check valve 1100 is not limited thereto.

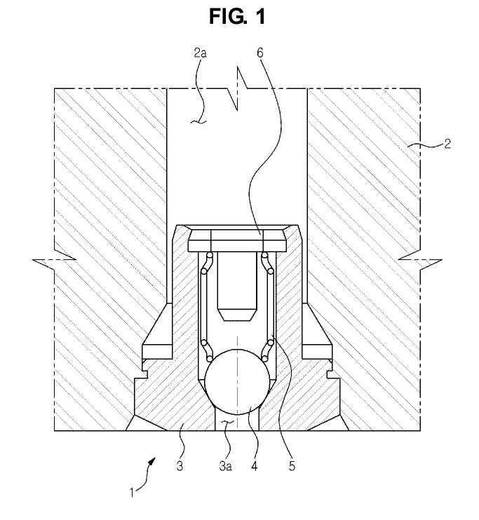

As illustrated, the check valve 1100 of the present embodiment includes a valve housing 1110 which is press-fitted into the hydraulic block (2, see FIG. 1) and defines an oil passage 1112 therein, a ball 1120 to open or close the oil passage 1112 of the valve housing 1110, a spring 1125 to elastically support the ball 1120, and a valve seat 1130 assembled to the valve housing 1110 to guide the spring 1125.

The hydraulic block 2, to which the check valve 1100 of the present embodiment is installed, has a hollow bore 2a to define an oil path therein. The bore 2a defining the oil path is stepped such that a diameter thereof gradually increases outward. The bore 2a includes an inner stepped portion 2b and an outer stepped portion 2c. In the present embodiment, the check valve 1100 is installed between the inner stepped portion 2b and the outer stepped portion 2c.

The valve housing 1110 has a hat-shaped cross section and the oil passage 1112 is formed in the center of the valve housing 1110. The valve housing 1110 includes an inner-diameter portion 1114 defining the oil passage 1112, a body portion 1116 expanded from the inner-diameter portion 1114, and an outer-diameter portion 1118 extending from the body portion 1116. The inner-diameter portion 1114 is concavely inclined to assist the ball 1120 in being stably supported in the oil passage 1112. The body portion 1116 has a cylindrical shape to allow the valve seat 1130 that will be described hereinafter to be press-fitted to the body portion 1116. The outer-diameter portion 1118 circumferentially extends from the body portion 1116 and is press-fitted into the perforated block 2. The valve housing 1110 has a more simplified configuration than the related art and may be manufactured at low cost by pressing or forging.

The valve seat 1130 has a multi-stage cylindrical shape. For example, the valve seat 1130 includes a first body portion 1130b, a second body portion 1130c and a third body portion 1130d. The first body portion 1130b is provided at the center thereof with an oil hole 1130a and extends in a bent shape from the oil hole 1130a to support the spring 1125 inserted therein. The second body portion 1130c has a greater diameter than the first body portion 1130b and is press-fitted to the body portion 1116 of the valve housing 1110. The third body portion 1130d circumferentially extends from the second body portion 1130c to come into surface contact with the outer-diameter portion 1118 of the valve housing 1110 and is press-fitted into the inner stepped portion 2b of the perforated block 2.

The ball 1120 comes into contact with the inner-diameter portion 1114 of the valve housing 1110 as described above. The spring 1125 is supported by the first body portion 1130b of the valve seat 1130 to press the ball 1120 toward the oil passage 1112.

In the case of the check valve 1100 in which the ball 1120, spring 1125 and valve seat 1130 are assembled to the valve housing 1110 as described above, after the third body portion 1130d of the valve seat 1130 is pushed inward so as to be connected to the inner stepped portion 2b of the perforated block 2, as illustrated in FIG. 3 in enlarged view, the outer stepped portion 2c located outward of the outer-diameter portion 1118 of the valve housing 1110 is press-deformed to surround the outer-diameter portion 1118 using an assembly tool (not shown). In this way, the check valve 1100 is fixed to the perforated block 2.

Accordingly, the check valve 1100 of the present embodiment may be easily manufactured and processed owing to changing the shapes of the valve housing 1110 and the valve seat 1130. Moreover, as a result of the outer-diameter portion 1118 of the valve housing 1110 and the third body portion 1130d of the valve seat 1130 being supported at both front and rear sides thereof by the perforated block 2, the check valve 1100 achieves easy fixing and assembly thereof.

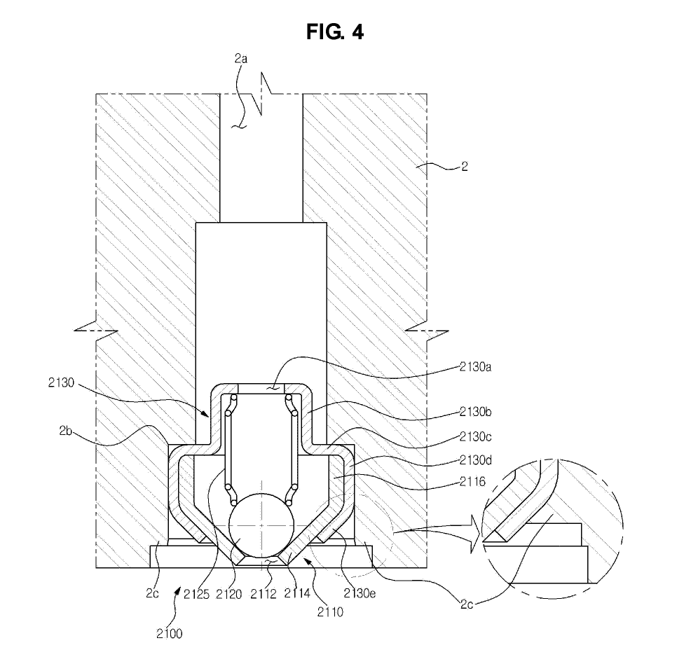

FIG. 4 is a view illustrating a check valve of a brake system according to another embodiment of the present invention. In the present embodiment, a check valve 2100 includes a valve housing 2110 which is press-fitted into the hydraulic block 2 and defines an oil passage 2112, a ball 2120 to open or close the oil passage 2112 of the valve housing 2110, a spring 2125 to elastically support the ball 2120, and a valve seat 2130 assembled to the valve housing 2110 to guide the spring 2125.

The hydraulic block 2, to which the check valve 2100 of the present embodiment is installed, has the hollow bore 2a to define an oil path therein. The bore 2a defining the oil path is stepped such that a diameter thereof gradually increases outward. The bore 2a includes the inner stepped portion 2b and the outer stepped portion 2c. In the present embodiment, the check valve 2100 is installed between the inner stepped portion 2b and the outer stepped portion 2c.

The valve housing 2110 has a house-shaped cross section. For example, the valve housing 2110 includes a tapered portion 2114 provided at the center thereof with the oil passage 2112, and a cylindrical body portion 2116 extending from the tapered portion 2114. The ball 2120 comes into contact with an inclined inner surface of the tapered portion 2114. The valve housing 2110 has a more simplified shape than the related art and may be manufactured at low cost by pressing or forging.

The valve seat 2130 has an arrow-shaped cross section. For example, the valve seat 2130 includes a cylindrical inner-diameter portion 2130b which is provided at the center thereof with an oil hole 2130a and extends in a bent shape from the oil hole 2130a to support the spring 2125 inserted therein, an inner-diameter expanding portion 2130c which circumferentially extends from the inner-diameter portion 2130b and is press-fitted into and supported by the inner stepped portion 2b of the perforated block 2, a cylindrical outer-diameter portion 2130d which extends perpendicular to the inner-diameter expanding portion 2130c and comes into contact at an inner surface thereof with the body portion 2116 of the valve housing 2110, and an outer-diameter reducing portion 2130e which is tapered from the outer-diameter portion 2130d and comes into surface contact with the tapered portion 2114 of the valve housing 2110. A length of the outer-diameter reducing portion 2130e may be determined such that the outer-diameter reducing portion 2130e extends beyond the outer stepped portion 2c after the outer stepped portion 2c is press-deformed, as illustrated in FIG. 4 in enlarged view.

The ball 2120 is configured to open or close the oil passage 2112 by selectively coming into contact with the tapered portion 2114 of the valve housing 2110. The spring 2125 is supported laterally and rearward by the inner-diameter portion 2130b of the valve seat 2130 so as to efficiently press the ball 2120 toward the oil passage 2112.

In the case of the check valve 2100 having the above-described configuration, prior to forming the outer-diameter reducing portion 2130e, the spring 2125, ball 2120 and valve housing 2110 are inserted into the valve seat 2130 having the same diameter as the outer-diameter portion 2130e. Thereafter, as the outer-diameter reducing portion 2130e is subjected to cramping by an assembly tool (not shown) so as to be shape-coincident with the tapered portion 2114 of the valve housing 2110, assembly of the check valve 2100 is completed.

After the assembled check valve 2100 is press-fitted into the perforated block 2 as the inner-diameter expanding portion 2130c of the valve seat 2130 is inserted to be coupled to a bottom surface (stepped surface) of the inner stepped portion 2b of the perforated block 2 and the outer-diameter portion 2130d of the valve seat 2130 is inserted to be coupled to a lateral surface of the inner stepped portion 2b, as illustrated in FIG. 4 in enlarged view, the outer stepped portion 2c located outward of the outer-diameter reducing portion 2130e of the valve seat 2130 is press-deformed to surround the outer-diameter reducing portion 2130c of the valve seat 2130 using an assembly tool (not shown). In this way, the check valve 2100 is stably fixed to the perforated block 2.

Accordingly, the check valve 2100 of the present embodiment may be easily manufactured and processed owing to changing the shapes of the valve housing 2110 and the valve seat 2130. Moreover, as a result of a rear side of the inner-diameter expanding portion 2130c of the valve seat 2130 and front both sides of the outer-diameter reducing portion 2130e of the valve seat 2130 being fixed between the inner stepped portion 2b and the outer stepped portion 2c of the perforated block 2, the check valve 2100 achieves easy fixing and assembly thereof.

As is apparent from the above description, a check valve of a hydraulic brake system according to one aspect has a simplified configuration in which the valve housing includes a concave inner-diameter portion defining a center oil passage, a cylindrical body portion expanded from the inner-diameter portion and an outer-diameter portion circumferentially extending from the body portion, and a valve seat includes a first body portion extending in a bent shape from an oil hole to support a spring therein, a second body portion having a greater diameter than the first body portion so as to be press-fitted to the body portion of the valve housing and a third body portion circumferentially extending from the second body portion to come into surface contact with the outer-diameter portion of the valve housing so as to be press-fitted into an inner stepped portion of a perforated block, whereby the check valve achieves size and weight reduction and is manufactured at low cost and high processing efficiency because it may be manufactured using conventional pressing. Furthermore, as a result of the outer-diameter portion of the valve housing and the third body portion of the valve seat being supported at both front and rear sides thereof by the perforated block, the check valve achieves easy fixing and assembly thereof, resulting in enhanced assembly reliability.

According to another aspect, a check valve of a hydraulic brake system has a simplified configuration in which a valve housing includes a tapered portion provided at the center thereof with an oil passage and a cylindrical body portion extending from the tapered portion, and a valve seat includes a cylindrical inner-diameter portion which extends in a bent shape from a center oil hole to support a spring inserted therein, an inner-diameter expanding portion which circumferentially extends from the inner-diameter portion and is press-fitted into and supported by an inner stepped portion of a perforated block, a cylindrical outer-diameter portion which extends perpendicular to the inner-diameter expanding portion and comes into contact at an inner surface thereof with the body portion of the valve housing, and an outer-diameter reducing portion which is tapered from the outer-diameter portion and comes into surface contact with the tapered portion of the valve housing, whereby the check valve achieves size and weight reduction and is manufactured at low cost and high processing efficiency because it may be manufactured using conventional pressing. Furthermore, as a result of both front and rear sides of the inner-diameter expanding portion of the valve seat and the outer-diameter reducing portion of the valve seat being fixed between inner and outer stepped portions of the perforated block, the check valve achieves easy fixing and assembly thereof, resulting in enhanced assembly reliability.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A check valve of a hydraulic brake system, the check valve comprising a valve housing press-fitted into an inner stepped portion of a perforated hydraulic block, the valve housing defining an inner oil passage, a ball accommodated in the valve housing to open or close the inner oil passage, a spring to elastically support the ball, and a valve seat coupled to the valve housing to guide the spring,
wherein the valve housing includes an inner-diameter portion provided at the center thereof with the oil passage, the inner-diameter portion having a concave shape to support the ball, a cylindrical body portion expanded from the inner-diameter portion, and an outer-diameter portion circumferentially extending from the body portion, and
wherein the valve seat includes a first body portion extending in a bent shape from an oil hole and configured to support the spring therein, a second body portion having a greater diameter than the first body portion and press-fitted to the body portion of the valve housing, a third body portion circumferentially extending from the second body portion to come into surface contact with the outer-diameter portion of the valve housing and be press-fitted into the inner stepped portion of the perforated block.

2. The check valve according to claim 1, wherein the perforated block further includes an outer stepped portion, and the outer stepped portion is press-deformed to fix the outer-diameter portion of the valve housing press-fitted into the inner stepped portion.

3. The check valve according to claim 1 or 2, wherein the outer-diameter portion of the valve housing and the third body portion of the valve seat are supported at both front and rear sides thereof by the perforated block.

4. A check valve of a hydraulic brake system, the check valve comprising a valve housing press-fitted into an inner stepped portion of a perforated hydraulic block, the valve housing defining an inner oil passage, a ball accommodated in the valve housing to open or close the inner oil passage, a spring to elastically support the ball, and a valve seat coupled to the valve housing to guide the spring,
wherein a valve housing includes a tapered portion provided at the center thereof with the oil passage, and a cylindrical body portion extending from the tapered portion, and
wherein a valve seat includes a cylindrical inner-diameter portion extending in a bent shape from a center oil hole to support a spring therein, an inner-diameter expanding portion circumferentially extending from the inner-diameter portion and press-fitted into and supported by the inner stepped portion of the perforated block, a cylindrical outer-diameter portion extending perpendicular to the inner-diameter expanding portion to come into contact at an inner surface thereof with the body portion of the valve housing, and an outer-diameter reducing portion tapered from the outer-diameter portion to come into surface contact with the tapered portion of the valve housing.

5. The check valve according to claim 4, wherein the perforated block further includes an outer stepped portion, and the outer stepped portion is press-deformed to fix the outer-diameter reducing portion of the valve seat press-fitted into the inner stepped portion.

6. The check valve according to claim 4 or 5, wherein the outer-diameter reducing portion and the inner-diameter expanding portion of the valve seat are supported at both front and rear sides thereof by the perforated block.

7. The check valve according to claim 6, wherein the outer-diameter reducing portion is formed by inserting the spring, ball and valve housing into the valve seat having the same diameter as the outer-diameter portion and thereafter, assembling the outer-diameter reducing portion so as to be shape-coincident with the tapered portion of the valve housing.
